(19) United States
(12) Patent Application Publication
(10) Pub. No.: US 2013/0258208 A1
(43) Pub. Date: Oct. 3, 2013

(54) AUDIO AND VIDEO GADGET

(71) Applicants: CHIH-DER CHUAN, Hukou Township (TW); Tze-Yun Sung, Hukou Township (TW)

(72) Inventors: CHIH-DER CHUAN, Hukou Township (TW); Tze-Yun Sung, Hukou Township (TW)

(21) Appl. No.: 13/434,855

(22) Filed: Mar. 30, 2012

(51) Int. Cl. H04N 5/64

(52) U.S. Cl. 348/744; 348/E05.128

(57) ABSTRACT

An audio and video gadget is an entertainment device provided with audio and video functions and communication functions and easily carried by a user. The audio and video gadget comprises a speaker set having a speaker therein and outputting power, a multimedia decoder over the speaker set, wherein the speaker set plays sound from the multimedia decoder, accompanying with video played by a phone, a light-emitting-diode lamp mounted with two sides of the multimedia decoder, wherein the light-emitting-diode lamp has an arc shape, a smart-phone pedestal over a top surface of the multimedia decoder, wherein the smart-phone pedestal is replaceable, and a pico projector over the light-emitting-diode lamp, wherein the light-emitting-diode lamp comprises a transmitting channel therein connected to the pico projector and the multimedia decoder, wherein the pico projector projects an image output from the multimedia decoder and the phone.

### BACKGROUND OF THE DISCLOSURE

a) Field of the Disclosure

The invention relates to an audio and video gadget, and more particularly, to an entertainment device provided with audio and video functions and communication functions and easily carried by a user.

b) Brief Description of the Related Art

Nowadays, accompanying with a household audio and video system for entertainment, called a multimedia player, typically used only for decoding, a display having a large screen becomes larger now, though thinner, than before. Accordingly, the display cannot be freely moved and carried and thus cannot provide various options for a user.

Compared with a traditional table light used only for illumination, a multimedia device designed like a table light has relatively comfortable arrangement over a table.

A traditional projecting system having an excessively large volume cannot be fitted with an easily carried multimedia player or mobile phone. Nevertheless, a pico projecting system having a minute volume, if fitted with a multimedia player or mobile phone commercialized with miniaturization and lightweight, is believed to be significantly more useful than ever.

A traditional mobile phone player is used only for one brand while a module set, if compatible with various smart phones having different brands, is believed to be convenient to lead a smart phone mounted thereon, regardless of which brand the smart phone is.

### SUMMARY OF THE DISCLOSURE

The present invention is directed to an audio and video gadget comprising a pico projector, a light-emitting-diode lamp, a smart-phone pedestal, a multimedia decoder and a speaker set, wherein the pico projector is positioned over the light-emitting-diode lamp and projects an image output from the multimedia decoder and a smart phone.

In one embodiment, an audio and video gadget comprises the pico projector, the light-emitting-diode lamp, the smart-phone pedestal, the multimedia decoder and the speaker set, wherein the light-emitting-diode lamp having an arc shape is provided with a transmitting channel therein connected to the pico projector and the multimedia decoder.

In one embodiment, an audio and video gadget comprises the pico projector, the light-emitting-diode lamp, the smart-phone pedestal, the multimedia decoder and the speaker set, wherein the smart-phone pedestal, positioned over a top surface of the multimedia decoder, is replaceable.

In one embodiment, an audio and video gadget comprises the pico projector, the light-emitting-diode lamp, the smart-phone pedestal, the multimedia decoder and the speaker set, wherein the multimedia decoder is positioned over the speaker set and has two sides mounted with the light-emitting-diode lamp.

In one embodiment, an audio and video gadget comprises the pico projector, the light-emitting-diode lamp, the smart-phone pedestal, the multimedia decoder and the speaker set, wherein the speaker set has a speaker therein and outputs power so as to play sound from the multimedia decoder, accompanying with video played by a smart phone.

The accompanying drawings are included to provide a further understanding of the invention, and are incorporated as a part of this specification. The drawings illustrate embodiments of the invention and, together with the description, serve to explain the principles of the invention.

### BRIEF DESCRIPTION OF THE DRAWINGS

The drawings disclose illustrative embodiments of the present disclosure. They do not set forth all embodiments. Other embodiments may be used in addition or instead. Details that may be apparent or unnecessary may be omitted to save space or for more effective illustration. Conversely, some embodiments may be practiced without all of the details that are disclosed. When the same numeral appears in different drawings, it refers to the same or like components or steps.

Aspects of the disclosure may be more fully understood from the following description when read together with the accompanying drawings, which are to be regarded as illustrative in nature, and not as limiting. The drawings are not necessarily to scale, emphasis instead being placed on the principles of the disclosure.

FIG. 1 is a schematic view of an audio and video gadget in accordance with the present invention.

While certain embodiments are depicted in the drawings, one skilled in the art will appreciate that the embodiments depicted are illustrative and that variations of those shown, as well as other embodiments described herein, may be envisioned and practiced within the scope of the present disclosure.

### DETAILED DESCRIPTION OF THE INVENTION

Illustrative embodiments are now described. Other embodiments may be used in addition or instead. Details that may be apparent or unnecessary may be omitted to save space or for a more effective presentation. Conversely, some embodiments may be practiced without all of the details that are disclosed.

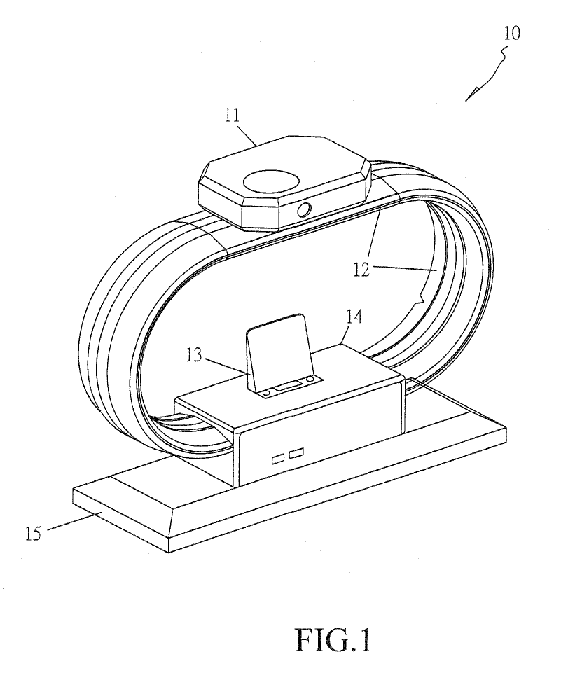

FIG. 1 is a schematic view of an audio and video gadget in accordance with the present invention. Referring to FIG. 1, an audio and video gadget 10 comprises a pico projector 11, a light-emitting-diode lamp 12, a smart-phone pedestal 13, a multimedia decoder 14 and a speaker set 15, wherein the pico projector 11 is positioned over the light-emitting-diode lamp 12 and projects an image output from the multimedia decoder 14 and a smart phone plugged with the smart-phone pedestal 13. The light-emitting-diode lamp 12 having an arc shape is provided with a transmitting channel therein connected to the pica projector 11 and the multimedia decoder 14. The smart-phone pedestal 13, positioned over a top surface of the multimedia decoder 14, is replaceable. The multimedia decoder 14 is positioned over the speaker set 15 and has two sides mounted with the light-emitting-diode lamp 12. The speaker set 15 has a speaker therein and outputs power so as to play sound from the multimedia decoder 14, accompanying with video played by a smart phone.

Referring to FIG. 1, in accordance with the present invention, the smart-phone pedestal 13 is replaceable based on various smart phones and thus the audio and video gadget 10 is much compatible to be applied and would not be bought again due to different smart phones.

Referring to FIG. 1, in accordance with the present invention, the audio and video gadget 10 is provided with the light-emitting-diode lamp 12 functioning as a table light and in a limited space of the table light, in consideration of performance of each parts, is arranged with the pico projector 11, the multimedia decoder 14 and the speaker set 15 so as to compose an integral structure. A center space enclosed by the arc-shaped light-emitting-diode lamp 12 integrated with the smart-phone pedestal 13 over the top surface of the multimedia decoder 14 composes an aesthetic and novel structure.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. Furthermore, unless stated otherwise, the numerical ranges provided are intended to be inclusive of the stated lower and upper values. Moreover, unless stated otherwise, all material selections and numerical values are representative of preferred embodiments and other ranges and/or materials may be used.

The scope of protection is limited solely by the claims, and such scope is intended and should be interpreted to be as broad as is consistent with the ordinary meaning of the language that is used in the claims when interpreted in light of this specification and the prosecution history that follows, and to encompass all structural and functional equivalents thereof.

What is claimed is:

1. An audio and video gadget, comprising:
a speaker set having a speaker therein and outputting power;
a multimedia decoder over the speaker set, wherein the speaker set plays sound from the multimedia decoder, accompanying with video played by a phone;
a light-emitting-diode lamp mounted with two sides of the multimedia decoder, wherein the light-emitting-diode lamp has an arc shape;
a smart-phone pedestal over a top surface of the multimedia decoder, wherein the smart-phone pedestal is replaceable; and
a pico projector over the light-emitting-diode lamp, wherein the light-emitting-diode lamp comprises a transmitting channel therein connected to the pico projector and the multimedia decoder, wherein the pico projector projects an image output from the multimedia decoder and the phone.
